(19) United States
(12) Patent Application Publication
(10) Pub. No.: US 2014/0283760 A1
(43) Pub. Date: Sep. 25, 2014

(54) Passage Device for Fauna

(71) Applicant: SAITEC, S.A., Vizcaya (ES)

(72) Inventors: Juan Ignacio Garcia Rey, Vizcaya (ES); Javier Urgoiti Martin, Vizcaya (ES); Francisco Javier Del Real Tunon, Vizcaya (ES)

(21) Appl. No.: 14/352,514

(22) PCT Filed: Oct. 3, 2012
(86) PCT No.: PCT/ES2012/070681

§ 371 Date: Apr. 17, 2014

(30) Foreign Application Priority Data
Nov. 9, 2011 (ES) P201131798

(51) Int. Cl. A01K 29/00

(52) U.S. Cl. CPC A01K 29/00
USPC 119/843

(57) ABSTRACT

The invention relates to a passage device for fauna, which includes a first support structure to which is connected an overhead door, and which has been designed both to enable the passage of fauna and to prevent said fauna from accessing the inside of an enclosure for roads, railway lines and other infrastructures or premises enclosed by a fence.

The main object of the invention herein relates to a passage device for fauna, characterised essentially in that it includes a first support structure to which an overhead door is connected, and which has been designed both to enable the passage of fauna and to prevent said fauna from accessing the inside of an enclosure for roads, railway lines and other infrastructures or premises enclosed by a fence.

### BACKGROUND OF THE INVENTION

Currently, fauna accessing the road infrastructure platform, such as roads or railway lines, is a safety issue for both people and fauna. The passage of an animal on a busy road can cause an accident due to the unpredictability of the animal passing by and other factors associated with driving. On the other hand, the consequences for the animal may be significant, especially in areas where there are endangered species.

Both in the case of high-speed railway lines and other infrastructure that have a perimeter fence, these problems are partially solved, preventing animals from accessing the possible collision zone.

However, since it is customary for fencing to be defective or damaged at certain points, animals can therefore access the platform. In these situations, the remaining problem is the inability of the animals to leave the fenced perimeter of the infrastructure, causing them to remain trapped in the fenced area, such that accidents are caused with negative consequences for the animal's life or for people and, in any case, there is a financial impact involved.

Accordingly, various solutions to prevent said animals from being enclosed in the aforementioned enclosures are known, for example, the Japanese patent JP2005240363, which discloses a ditch type device with open side elements for small animals to exit or pass through, when drainage occurs through the ditch channel. Said ditch has opposite walls on each side, which have a plurality of steps or elements that enable the animals to exit. The assembly is U-shaped between the bottom and the sides of the ditch.

### DESCRIPTION OF THE INVENTION

The technical problem solved by the present invention is to prevent fauna from becoming trapped in enclosures, such as certain roads, railways lines, etc. To this end, the passage device for fauna, object of the invention herein, comprises a first support structure connected to an overhead door, which enables the passage of fauna with minimal effort by the animal.

This device solves the technical problem in a simple, universal and efficient manner when compared with the methods, devices and systems known in the state of the art, especially in the case of longitudinal drainage junctions, avoiding weak points in the closure, and further enabling the removal of any material that is dragged along the drainage system during rainy periods, thereby preventing clogging.

The passage device includes two essential elements, wherein the first element is a support structure formed by a sheet three-dimensionally adapted to the ditch or interceptor ditch, covering the surface, and forming a closed canal with the same light as the drainage section. Said structure is adapted to cover a small section of the drainage system, and should be in contact with the bottom of the enclosure in the area where it crosses the drainage system, avoiding any gaps that allow fauna to enter the site.

The size of the support structure will vary depending on the width of the drainage system and the skew angle. The width should be at least equal to or greater than the width of the drain to which it is adapted. The length may be uniform across the entire width (rectangular shape), or variable (triangular or trapezoidal in shape).

The support structure may allow the passage of water and light, although in the latter case, the mesh size cannot be larger than that of the fence.

Said structure is anchored firmly and stably to the outer edges or walls of the drainage system, by means a plurality of connecting elements, standard bolts, resins, adhesives or any solution with equivalent mechanical properties. Any other simple fastening means, such as, for example, tacking the bottom edge of the fence by welding, securing with wire or plastic strips, may be used.

In any case, the purpose of fastening is to avoid clearances that lead to the appearance of gaps that encourage animals to enter the bottom part of the fence.

The aforementioned structure will be made in the form of a sheet of continuous or perforated material or formed by a regular lattice, the possible materials for the embodiment being diverse, such as plastic, metal, wood, concrete or other, preferably inflexible, materials with similar technical properties.

Integrally joined to this support structure, an overhead door is secured by means of a hinge or other similar structure that enables rotation between them, in a variable manner, depending on the section of the ditch or interceptor ditch, although its height will be greater than the height of the ditch, such that the door forms an angle close to 45° with the base of the ditch, which substantially reduces the effort required by the animal to lift the cover and access the outside, while making it impossible for any animal to go in the opposite direction and enter the fenced area.

The base of the overhead door may be slightly wider (about one or two centimetres) than the base of the ditch, in order for there to be a sufficient gap between the base of the ditch and the overhead door, which suggests a possible exit to the animal, while allowing the removal of solids from the drain with a minimal sheet of water without actuating the door.

The overhead door shall consist of a structure, preferably quadrilateral, formed by metal or plastic parts or another material having equivalent mechanical properties, secured together. A mesh, similar in size to that of the fence at its most dense part, is affixed to this structure.

Optionally, for doors fitted in interceptor ditches, a spring or a counterweight can be fitted, similar to the weight of the door at the upper part thereof, in order to balance the weight of the door, and to further enable the opening thereof by an animal or by water dragging materials. The mechanism must ensure that the door returns to its initial position when the slight force from the inside stops.

Additionally, the device may temporarily or permanently include, an electronic registration system in order to establish its effectiveness, such as cameras, video cameras, radio frequency readers, and others.

Throughout the description and claims the word “comprise” and variants thereof are not intended to exclude other technical characteristics, addends, components or steps. For persons skilled in the art, other objects, advantages and characteristics of the invention will emerge partly from the description and partly from implementing the invention. The following examples and drawings are provided by way of illustration, and not intended to be limiting of the present invention. Furthermore, the invention herein covers all possible combinations of particular and preferred embodiments set forth herein.

### BRIEF DESCRIPTION OF THE FIGURES

Described very briefly hereinafter are a series of drawings that help to better understand the invention and which are expressly related to an embodiment of said invention that is presented as a non-limiting example thereof.

FIG. 1 shows a plan view of an example of a typical installation of the passage device for fauna, object of the invention herein.

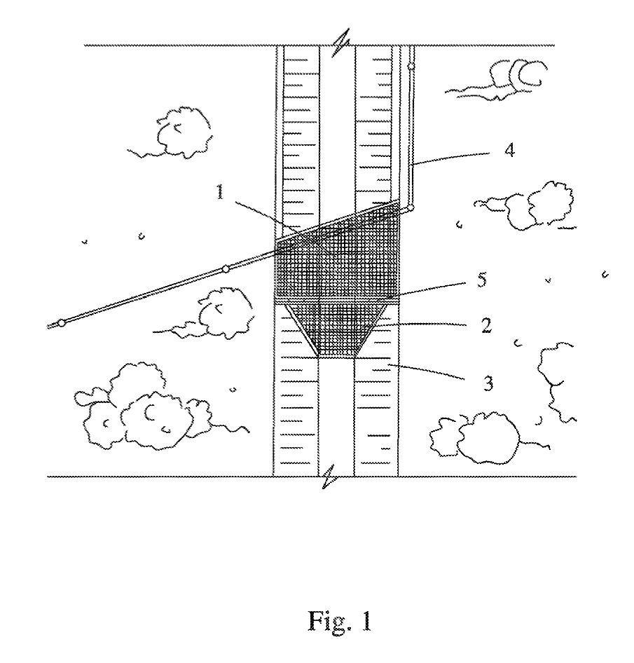

FIG. 2 shows a side view of the passage device for fauna, object of the invention herein.

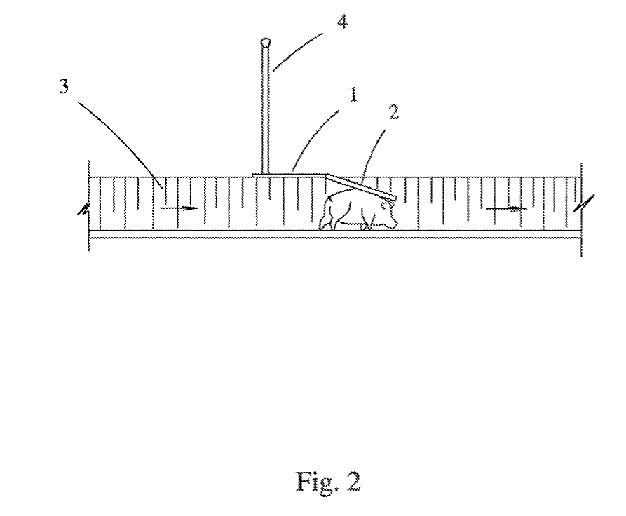

FIG. 3 shows a view of different configurations of the passage device for fauna, object of the invention herein.

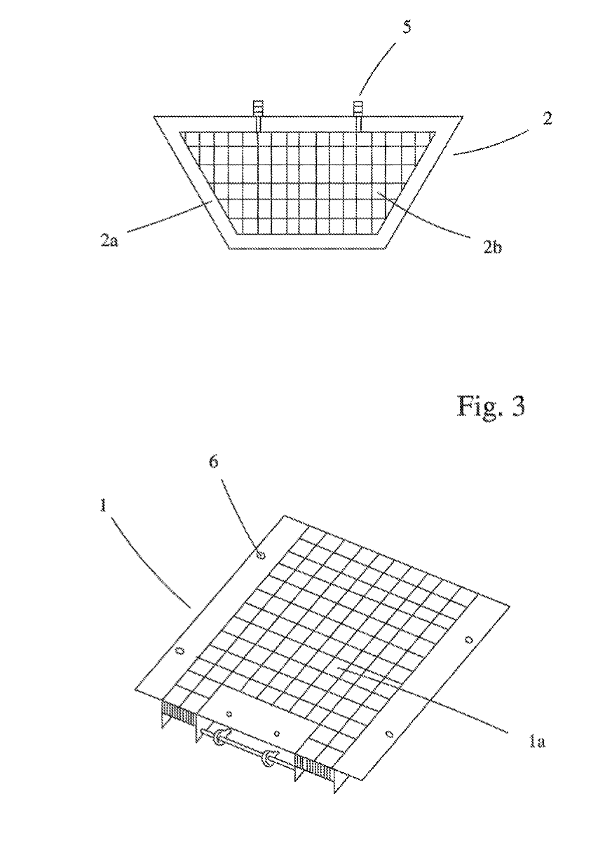

FIG. 4 shows a view of a practical embodiment of the overhead door with a counterweight, as part of the passage device for fauna, object of the invention herein.

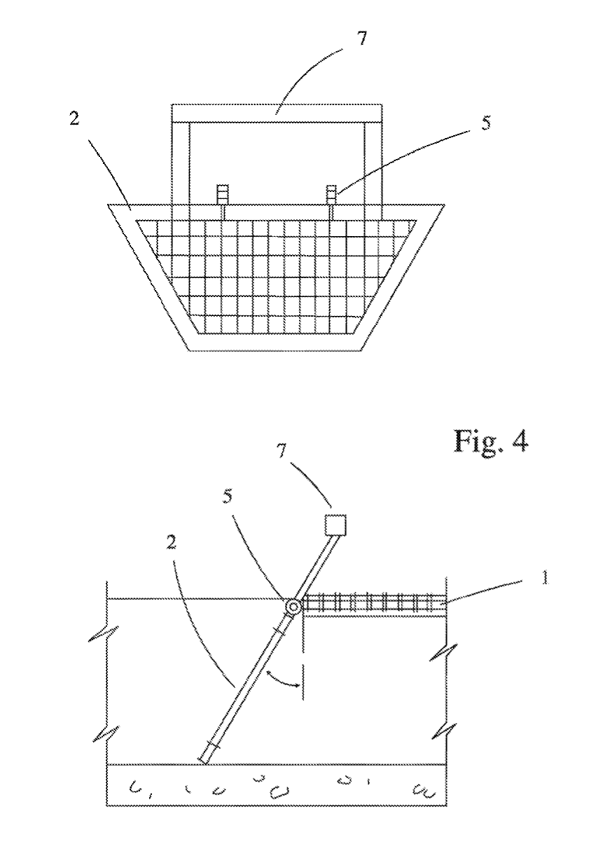

### PREFERRED EMBODIMENT OF THE INVENTION

A preferred embodiment of the invention is shown in the attached drawings. More specifically, the passage device for fauna, object of the present invention comprises a first support structure (1), anchored to a ditch (3) and connected to an overhead door (2), to enable the passage of fauna from an enclosure (4) with minimal effort by the animal.

The support structure (1) shall consist of an adapted sheet (1a) three-dimensionally adapted to the ditch (3), covering the surface, and forming a closed canal with the same light as the section of drainage.

The size of the support structure will vary depending on the width of the drainage system and the skew angle. The width should be at least equal to or greater than the width of the drain to which it is adapted. The length may be uniform across the entire width (rectangular shape), or variable (triangular or trapezoidal in shape).

Said structure is anchored (1) firmly and stably to the outer edges or walls of the drainage system, by means a plurality of connecting elements (6), standard bolts, resins, adhesives or any solution with equivalent mechanical properties, being able to use any other simple fastening means, such as: “tacked” to the bottom edge of the fence by welding, tied with wire or plastic strips. The purpose of the above is to avoid clearances that lead to the appearance of gaps that encourage animals to enter the bottom part of the fence.

Said structure will be made in the form of a sheet of inflexible material, that is continuous, perforated or formed by a lattice, the embodiment being of different materials such as plastic, metal, wood, concrete or other materials with similar technical characteristics.

Integrally joined to the support structure (1), an overhead door (2) is secured by means of a hinge (5) or other similar structure that enables rotation between them, in a variable manner, and higher than the ditch (3), to form an angle close to 45° with the base of the ditch (3).

The base of the overhead door (2) may be slightly wider (about a few centimetres) than the base of the ditch (3), in order for there to be a sufficient gap between the base of the ditch (3) and the overhead door (2), which suggests a possible exit to the animal, while allowing the removal of solids from the drain with a minimal sheet of water without actuating the door.

Said overhead door (2) shall consist of a structure (2a), preferably quadrilateral, formed by metal or plastic parts or another material having equivalent mechanical properties, secured together. A mesh (2b), similar in size to that of the fence at its most dense part, is affixed to this structure (2a).

In one of its non-limiting practical embodiments the overhead door may include a spring or a counterweight (7), similar to the weight of the door at the upper part thereof, in order to balance the weight of the door (2), and to further enable the opening thereof by an animal or by water dragging materials, and subsequently returning to its initial position.

In turn, the device may temporarily or permanently include, an electronic registration system in order to establish its effectiveness, such as cameras, video cameras, radio frequency readers, and others.

1. Passage device for fauna configured to enable the passage of fauna from an enclosure (4) with minimal effort by an animal characterised in that it comprises a first support structure (1), anchored to a ditch (3) at its outer edges, and where said structure (1) is connected, the device comprises an overhead door (2) by means of a rotating member (5) to form an angle of approximately 45°-60° with the base of the ditch (3).

2. Passage device for fauna according to claim 1 characterised in that the support structure (1) shall consist of a sheet (1a) three-dimensionally adapted to the ditch (3), covering the surface, and forming a closed canal with the same light as the section of drainage, being manufactured as a sheet of an inflexible, continuous, perforated material or material formed by a lattice.

3. Passage device for fauna according to claims 1 and 2 characterised in that the size of the support structure (1) depends on the width of the drainage system and the skew angle, with the width equal to or greater than the width of the drain to which it adapts, and wherein the length of said structure (1) varies according to the shape, being uniform over the entire width when rectangular, and variable when triangular or trapezoidal in shape.

4. Passage device for fauna according to claims 1 to 3 characterised in that the structure (1) is anchored to the outer edges of the ditch (3) by a plurality of connecting elements (6).

5. Passage device for fauna according to claim 1 characterised in that the base of the overhead door (2) is wider than the base of the ditch (3).

6. Passage device for fauna according to claims 1 and 5 characterised in that said overhead door (2) is composed of a structure (2a), preferably quadrilateral, and formed by a plurality of parts integrally connected, to which a mesh (2b) is affixed, similar in size to that of the fence at its most dense part.

7. Passage device for fauna according to claims 1, 5 and 6, characterised in that the overhead door comprises a spring or a counterweight (7), similar to the weight of the door at the upper part thereof in order to balance the weight of the door (2).

8. Passage device for fauna according to the preceding claims, characterised in that the rotating member (5) is a hinge or other similar structure.
